(19) United States
(12) Patent Application Publication
(10) Pub. No.: US 2006/0102438 A1
(43) Pub. Date: May 18, 2006

(54) Actuation unit for an electromechanically operated disk brake

(76) Inventors: Bernward Bayer, Rodermark/Ober-Roden (DE); Volker Hartel, Germering (DE); Enno Kelling, Eschborn (DE); Paul Linhoff, Neu-Anspach (DE); Bernd Piller, Dreieich (DE); Andreas Schirling, Pfungstadt (DE); Bernhard Schmittner, Hosbach (DE); Jurgen Volkel, Frankfurt (DE)

Correspondence Address: RATNERPRESTIA, P O BOX 980, VALLEY FORGE, PA, 19482-0980, US

(21) Appl. No.: 10/524,384

(22) PCT Filed: Aug. 11, 2003
(86) PCT No.: PCT/EP03/08907

§ 371 Date: Aug. 30, 2005

(30) Foreign Application Priority Data
Aug. 14, 2002 (DE) 102 37 180.6
Oct. 24, 2002 (DE) 102 49 478.9
Apr. 2, 2003 (DE) 103 14 798.5

(51) Int. Cl. F16D 65/36

(52) U.S. Cl. 188/156

(57) ABSTRACT

An actuating unit is provided for an electromechanically actuated disc brake for automotive vehicles, which is disposed on a brake caliper wherein two friction linings respectively cooperating with a side face of a brake disc are arranged in a manner displaceable to a limited extent, with one of said friction linings being arranged so as to be directly movable into engagement with the brake disc by means of an actuating element, through the actuating unit, while the other friction lining is movable into engagement with the brake disc through the action of a reaction force applied by the brake caliper. The actuating unit comprises an electric motor and at least one reduction gear operatively arranged between the electric motor and the first friction lining. The reduction gear is formed as a threaded drive which, for guiding the threaded nut, includes a cylindrical guide piece that is provided with a sensor device for sensing the reaction force. To realize a design suitable for large series production, the invention discloses that the guide piece has a reduced thickness of material or an aperture in the area of attachment of the sensor device, and a prefabricated sensor module that allows testing outside the guide piece and forms the sensor device is arranged in the area of attachment or within or above the aperture.

### TECHNICAL FIELD

The present invention generally relates to actuating units and more particularly relates to an actuating unit for an electromechanically actuated disc brake for automotive vehicles.

### BACKGROUND OF THE INVENTION

An electro-mechanical actuating unit of the afore-described type is disclosed in International Patent Application WO 01/73312 A1. In the afore-mentioned actuating unit the reaction force is determined by means of wire strain gages cemented to the surface of the guide piece.

The prior art actuating unit suffers especially from the fact that mounting the wire strain gages on the guide piece is inappropriate for a process that lends itself to industrialization.

### BRIEF SUMMARY OF THE INVENTION

It is, therefore, an object of the invention to provide an electromechanical actuating unit of the afore-described type that is appropriate for economical large series production.

This object is achieved by the present invention in that the guide piece includes a reduced thickness of material or an aperture in the area of attachment of the sensor device, and a prefabricated sensor module that allows testing outside the guide piece and forms the sensor device is arranged in the area of attachment or in or above the aperture.

### BRIEF DESCRIPTION OF THE DRAWINGS

FIG. 1 is a sectional axial view of a design of the electro-mechanical actuating unit of the invention.

FIG. 2 is a simplified view of the guide piece used in the design according to FIG. 1.

FIG. 3 is a simplified view of another guide piece that can be used in the design according to FIG. 1.

### DETAILED DESCRIPTION OF THE PREFERRED EMBODIMENTS

The electromechanically operable disc brake of the invention as illustrated in the drawing is basically composed of a brake caliper or floating caliper 1 being slidably mounted in a stationary holder (not shown), a driving unit 2 partly shown in an axial cross-section, and a brake disc 3. A pair of friction linings 4 and 5 is so arranged in the brake caliper 1 as to face the right-hand and left-hand side faces of the brake disc 3.

Herein below the friction lining 4 shown in the drawing to the right thereof is designated by ‘first or inboard friction lining’, while the friction lining provided with reference numeral 5 is designated by ‘second or outboard friction lining’. While the first friction lining 4 is directly movable into engagement with brake disc 3 by means of an actuating element 7, through the actuating unit 2, the second friction lining 5, due to the action of a reaction force applied during actuation of the assembly by the brake caliper 1, is urged against the opposite side face of the brake disc 3 so that a braking force is exerted on the brake disc 3. As this occurs, the second friction lining 5 can be rigidly connected to the brake caliper 1.

The actuating unit mounted on the brake caliper 1 by means of fastening means not shown is mainly composed of two separable subassemblies or modules that can be tested independently of one another, namely of a driving unit, i.e. an electric motor 10, and a reduction gear 11 actuating the first friction lining 4.

In the example shown, the reduction gear 11 is designed as a ball-type threaded drive 16 to 18 mounted in a gear housing 19, which can also be designed integrally with the afore-mentioned brake caliper 1. The ball-type threaded drive comprises a threaded nut 16 and a threaded spindle 17, with a plurality of balls 18 provided between the threaded nut 16 and the threaded spindle 17 circulating upon a rotary movement of the threaded spindle 17, thereby causing an axial or translatory movement of the threaded nut 16.

Preferably, the arrangement is such that the non-illustrated rotor of the electric motor 10 drives the threaded. spindle 17, while the threaded nut 16 forming the above-mentioned actuating element 7 is coupled to the first friction lining 4 in such a fashion that both pressure forces and traction forces are transmitted. Further, a bowl-shaped guide piece 20 is provided that radially embraces the ball-type threaded drive 16 to 18, is axially supported on the gear housing 19 and accommodates the threaded nut 16 in an axially displaceable manner. The threaded nut 16 is mounted in the guide piece 20 in its area facing the first friction lining 4 by means of a slide ring 25 arranged in the guide piece 20.

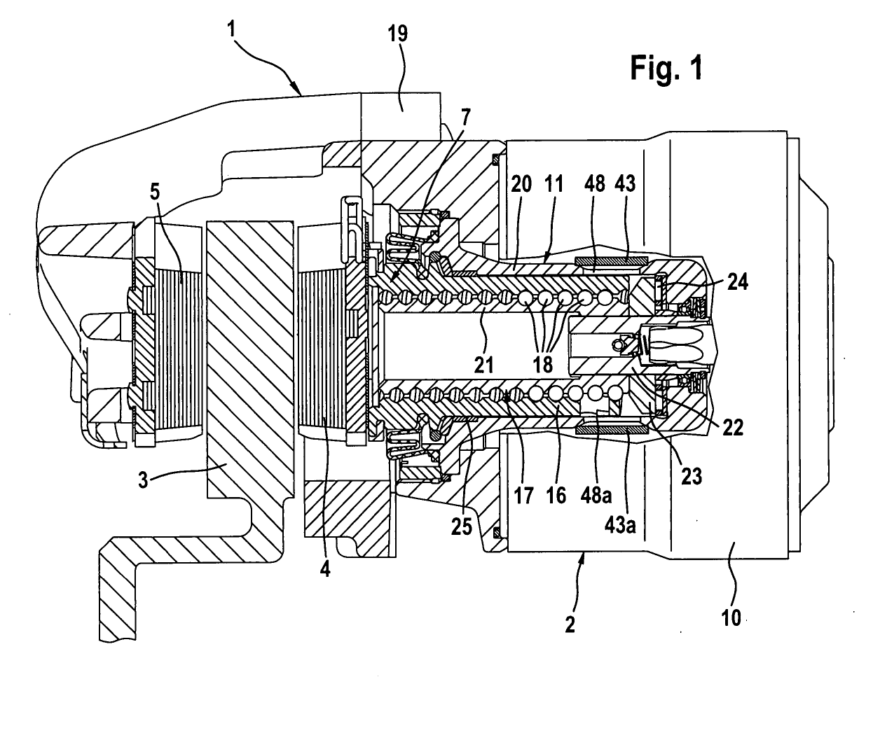

The threaded spindle 17 driven by the electric motor 10 has a three-part design in the example illustrated and is composed of a tubular first spindle portion 21 cooperating with the threaded nut 16, a second spindle portion 22 cooperating with the electric motor 10, and an annular third spindle portion 23 that is supported on an axial bearing 24 arranged in the guide piece 20. In this arrangement, the first spindle portion 21 with the threaded nut 16 limits helical threaded grooves in which balls 18 circulate. At least one sensor device 43, 43a, indicated only schematically in FIG. 1, is used to sense the reaction force applied by the brake caliper 1 upon actuation of the disc brake, and the guide piece 20 includes apertures 48, 48a in the area of attachment of the sensor devices.

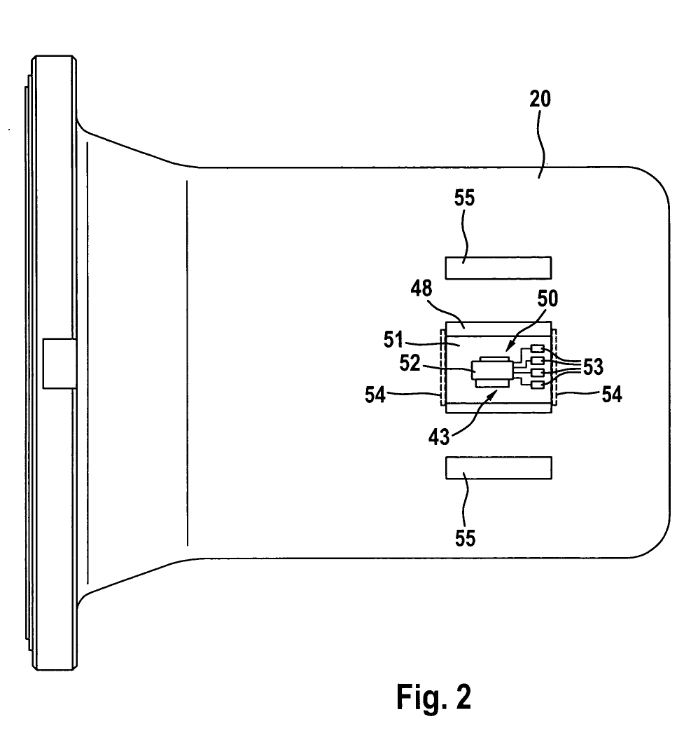

As can be seen in FIG. 2 in particular, the above-mentioned sensor device 43, which permits indirectly determining the actuating or clamping force by way of the axial deformation of the guide piece 20, is designed as an externally manufactured sensor module 50 that allows independent testing. Sensor module 50 is basically composed of a preferably metallic carrier element 51, a measuring element 52, and contact points 53 only represented. The sensor module 50 is attached to the guide piece 20 by means of laser welding, as is indicated by welding seams 54. Slits 55 provided on either side of the aperture 48 serve for a thermal relief of the area of attachment of the sensor module 50, which can be connected to the guide piece 20 by temperature processes, preventing temperature-induced distortions from taking effect on the surroundings of the sensor device 43.

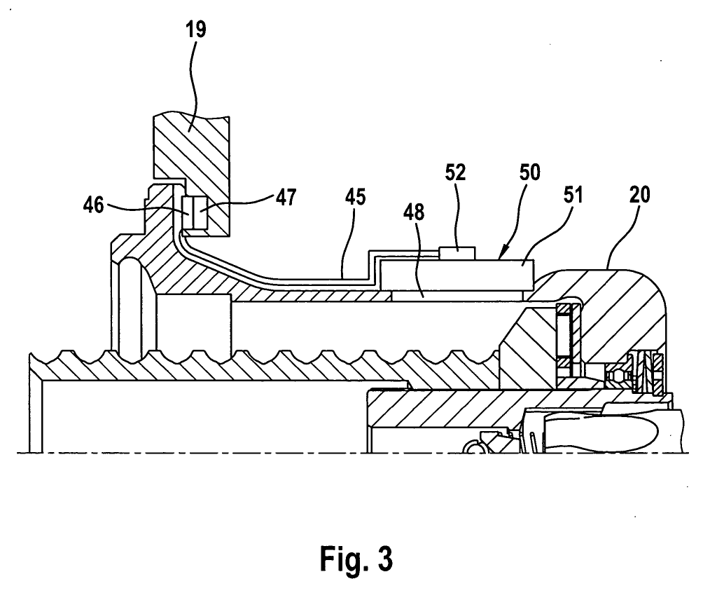

Finally, FIG. 3 shows another design variation of the sensor module 50, whose carrier element 51 is configured as a tension member. A contact grid 45 preferably punched from metal is used for the electrical connection of the sensor module 50, said contact grid being secured to the guide piece 20 and leading to an electric interface 46. A flexible foil, cable, etc. can be provided alternatively for contacting purposes. Interface 46 is preferably configured as a plug attached to the guide piece 20. The electrical connection to an electronic evaluating unit (not shown) is carried out during the final assembly by means of a counterplug 47 integrated in the gear housing 19. The same type of contacting can, of course, also be used in the variant shown in FIG. 2.

A number of modifications are, of course, also feasible within the spirit of the invention. Thus, it is e.g. possible to arrange a second reduction gear, favorably a planetary gear, between the electric motor 10 used as driving unit and the reduction gear 2. It is naturally also possible to provide gears achieving great gear reductions by means of a deformable toothed ring and eccentricity.

1.-7. (canceled)

8. An actuating unit for an electromechanically actuated disc brake for automotive vehicles, which is disposed on a brake caliper wherein two friction linings respectively cooperating with a side face of a brake disc are arranged in a manner displaceable to a limited extent, with one of said friction linings being arranged so as to be directly movable into engagement with the brake disc by means of an actuating element, through the actuating unit, while the other friction lining is movable into engagement with the brake disc through the action of a reaction force applied by the brake caliper, wherein the actuating unit comprises an electric motor and at least one reduction gear operatively arranged between the electric motor and the first friction lining, and with the reduction gear being formed of a threaded drive accommodated in a gear housing and including a cylindrical guide piece that is provided with a sensor device for sensing the reaction force, wherein the guide piece has a reduced thickness of material or an aperture in the area of attachment of the sensor device, and a prefabricated sensor module that allows testing outside the guide piece and forms the sensor device is arranged in the area of attachment or within or above the aperture.

9. An actuating unit according to claim 8,
wherein the sensor module includes a carrier element on which a measuring element and contacting means are arranged.

10. An actuating unit according to claim 8,
wherein the carrier element is welded, preferably laser welded, to the guide piece.

11. An actuating unit according to claim 8,
wherein the carrier element is configured as a tension member.

12. An actuating unit according to claim 8,
wherein recesses or slits are provided in the guide piece close to the area of attachment of the sensor device.

13. An actuating unit according to claim 11,
wherein a contact grid punched from metal or flexible foils is provided for contacting the sensor device.

14. An actuating unit according to claim 8,
wherein an electric interface or a plug, to which the metal grid is connected, is arranged in the area of the guide piece facing the friction lining.
